(19) United States
(12) Patent Application Publication
(10) Pub. No.: US 2024/0270132 A1
(43) Pub. Date: Aug. 15, 2024

(54) JUVENILE RESTRAINT

(71) Applicant: Dorel Juvenile Grouop, Inc., Foxboro, MA (US)

(72) Inventors: Sander Geradus Toonders, ET Valkenswaard (NL); Donald Hendrikus van Montfort, Heythuysen (NL)

(21) Appl. No.: 18/439,112

(22) Filed: Feb. 12, 2024

(30) Foreign Application Priority Data
Feb. 13, 2023 (EP) 23156275.2

(51) Int. Cl. B60N 2/28

(52) U.S. Cl. CPC B60N 2/2869; B60N 2/2821; B60N 2/2845

(57) ABSTRACT

A juvenile restraint includes a seat base adapted to be mounted to a vehicle seat, a child vehicle seat adapted to secure a child for transportation in a vehicle, and a seat-configuration controller to change the child vehicle seat between a transportation configuration, a lateral-retracted configuration, and a lateral-extended configuration.

### PRIORITY CLAIM

This application claims priority to European Patent Application No. EP23156275.2, filed Feb. 13, 2023, which is expressly incorporated by reference herein.

### BACKGROUND

The present disclosure relates to a juvenile restraint, and particularly to a juvenile restraint including a child vehicle seat. More particularly, the present disclosure relates to a juvenile restraint including a child vehicle seat and a seat base detachably connectable to a vehicle seat SUMMARY

According to the present disclosure, a juvenile restraint includes a seat base adapted to be mounted to a vehicle seat and a child vehicle seat adapted to secure a child for transportation in a vehicle.

In illustrative embodiments, the juvenile restraint further includes a seat-configuration controller coupled to the seat base and the child vehicle seat. The seat-configuration controller changes the child vehicle seat between a transportation configuration in which the child faces the front or rear of the vehicle, a lateral-retracted configuration in which the child faces a lateral side of the vehicle, and a lateral-extended configuration in which the child vehicle seat is translated towards a door of the vehicle.

In illustrative embodiments, the seat-configuration controller includes a seat mount that couples with the child vehicle seat for movement therewith, a seat-pivot unit that rotates relative to the seat base to rotate the child vehicle seat about a center pivot axis, and a seat-slide unit that slides the child vehicle seat relative to the seat base.

In illustrative embodiments, the seat-pivot unit rotates the child vehicle seat about the center pivot axis between the transportation configuration and the lateral-retracted configuration. The seat-slide unit slides the child vehicle seat between the lateral-retracted configuration and the lateral-extended configuration.

In illustrative embodiments, the child vehicle seat, the seat mount, and a first portion of the seat-slide unit extend laterally away from the seat base, the seat-pivot unit, and a second portion of the seat-slide unit when the child vehicle seat is in the lateral-extended configuration. In such a configuration, the seat base, the seat-pivot unit, and the second portion of the seat-slide unit are secure to the vehicle seat while the child is move into or out of the child vehicle seat or a caregiver is placing or removing the child vehicle seat on or from the seat mount.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is an exploded perspective view of a first embodiment of a portion of a juvenile restraint in accordance with the present disclosure;

FIG. 2 is a half-exploded and half assembled perspective view of the portion of the juvenile restraint of FIG. 1;

FIG. 3 is an assembled perspective view of a rotating part and a base of the juvenile restraint as shown in FIG. 1, with the rotating part being locked to the base;

FIG. 3A is an enlarged view of detail IIIA of FIG. 3;

FIG. 4 is an exploded perspective view of a part of first locking means of the juvenile restraint of FIG. 1;

FIG. 5 is a top view of the rotating part and the base of FIG. 3;

FIG. 5A is a sectional view taken along line F-F of FIG. 5;

FIG. 5B is a sectional view taken along line G-G of FIG. 5;

FIG. 5C is an enlarged view of detail VF shown in FIG. 5B;

FIG. 5D is an enlarged view of detail VE shown in FIG. 5A;

FIG. 5E is an enlarged view of detail VC shown in FIG. 5;

FIG. 5F is an enlarged view of detail VD shown in FIG. 5;

FIG. 6 is an assembled perspective view of the rotating part and the base of the juvenile restraint as shown in FIG. 1, with the rotating part being locked to the base in a rotated position;

FIG. 6A is an enlarged view of detail VIA shown in FIG. 6;

FIG. 7 is a top view of the rotating part and the base of FIG. 6;

FIG. 7A is a sectional view taken along line C-C of FIG. 7;

FIG. 7B is an enlarged view of detail VIIB shown in FIG. 7A;

FIG. 7C is a sectional view taken along line D-D of FIG. 7;

FIG. 7D is an enlarged view of detail VIID shown in FIG. 7C;

FIG. 8 is an assembled perspective view of a sliding part of the juvenile restraint as shown in FIG. 1, the sliding part being locked in a starting position;

FIG. 9 is a top view of the sliding part of FIG. 8;

FIG. 9A is a sectional view taken along line E-E of FIG. 9;

FIG. 9B is an enlarged view of detail IXB shown in FIG. 9A;

FIG. 10 is an assembled perspective view of the sliding part of the juvenile restraint as shown in FIG. 1, the sliding part being locked in an intermediate position;

FIG. 11 is an exploded perspective view of detail XI of FIG. 10, showing a first embodiment of a pen-dent mechanism of the juvenile restraint;

FIG. 12 is a top view of the sliding part of FIG. 10;

FIG. 12A is a sectional view taken along line H-H of FIG. 12;

FIG. 12B is an enlarged view of detail XIIB shown in FIG. 12A;

FIG. 12C is a sectional view taken along line I-I of FIG. 12;

FIG. 12D is an enlarged view of detail XIID shown in FIG. 12C;

FIG. 12E is a sectional view taken along line J-J of FIG. 12;

FIG. 12F is an enlarged view of detail XIIF shown in FIG. 12E;

FIG. 13 is an exploded perspective view of detail XIVA of FIG. 14, showing a second embodiment of a pin-dent mechanism of the juvenile restraint;

FIG. 14 is a sectional view of the sliding part with a second embodiment of a pin-dent mechanism of the child vehicle seat;

FIG. 14A is an enlarged view of detail XIVA shown in FIG. 14;

FIG. 15 is an exploded perspective view of a child seat unlocking means of the juvenile restraint as shown in FIG. 1;

FIG. 15A is an enlarged view of detail XVA shown in FIG. 15;

FIG. 15B is an enlarged view of detail XVB shown in FIG. 15;

FIG. 16 is an assembled perspective view of the child seat unlocking means as shown in FIG. 15, in which the child seat unlocking means being in a locked state;

FIG. 16A is an enlarged view of detail XVIA shown in FIG. 16;

FIG. 16B is an enlarged view of detail XVIB shown in FIG. 16;

FIG. 16C is an enlarged view of detail XVIC shown in FIG. 16;

FIG. 17 is an assembled perspective view of the child seat unlocking means, in which the child seat unlocking means being in an unlocked state;

FIG. 17A is an enlarged view of detail XVIIA shown in FIG. 17;

FIG. 17B is an enlarged view of detail XVIIB shown in FIG. 17;

FIG. 17C is an enlarged view of detail XVIIC shown in FIG. 17;

FIG. 18 is a perspective view of the juvenile restraint as shown in FIG. 1, in which the child vehicle seat being in a forward facing position;

FIG. 19 is a perspective view of the juvenile restraint as shown in FIG. 1, in which the child vehicle seat being in a side facing position;

FIG. 20 is perspective view of the juvenile restraint as shown in FIG. 1, in which the child vehicle seat being in a side facing position, whereby the sliding part is in a sliding-out position;

FIG. 21 is a front view of a juvenile restraint seen in a direction opposite to the driving direction of the vehicle, whereby a first kind of child seat is in a side facing position; and

FIG. 22 is a front view of a juvenile restraint seen in a direction opposite to the driving direction of the vehicle, whereby a second kind of child seat is in a side facing position.

### DETAILED DESCRIPTION

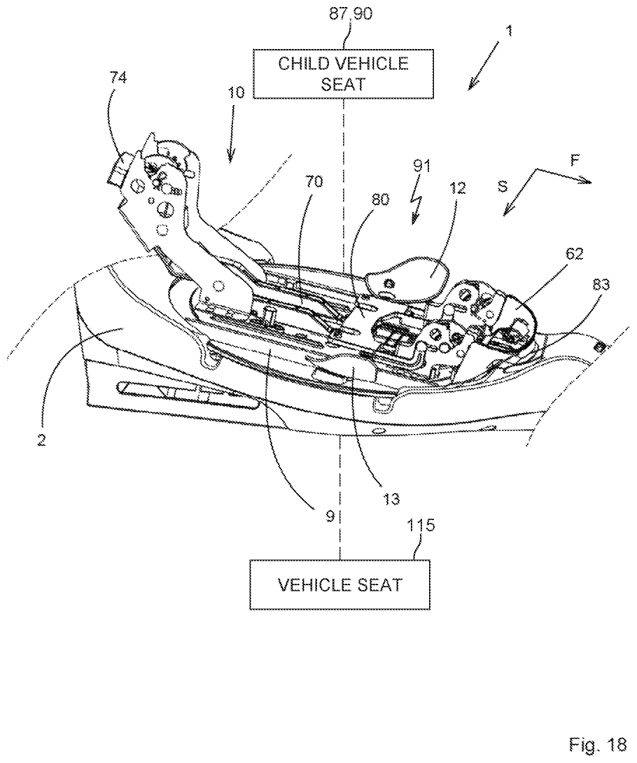

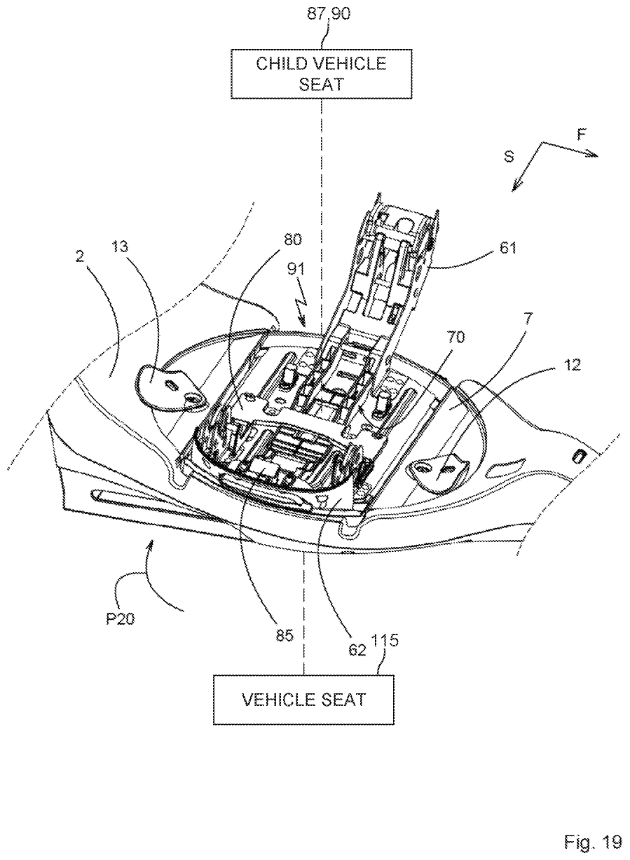

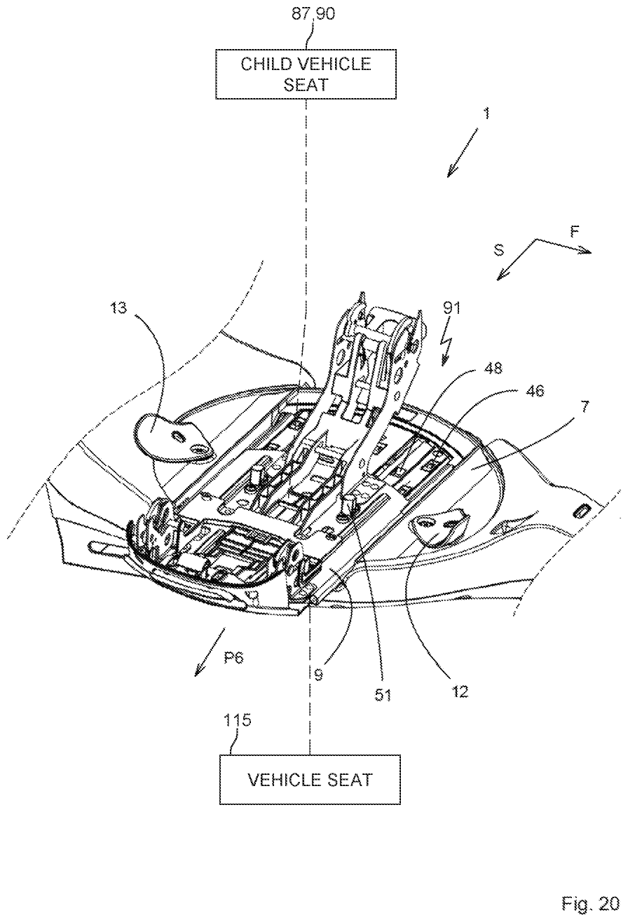

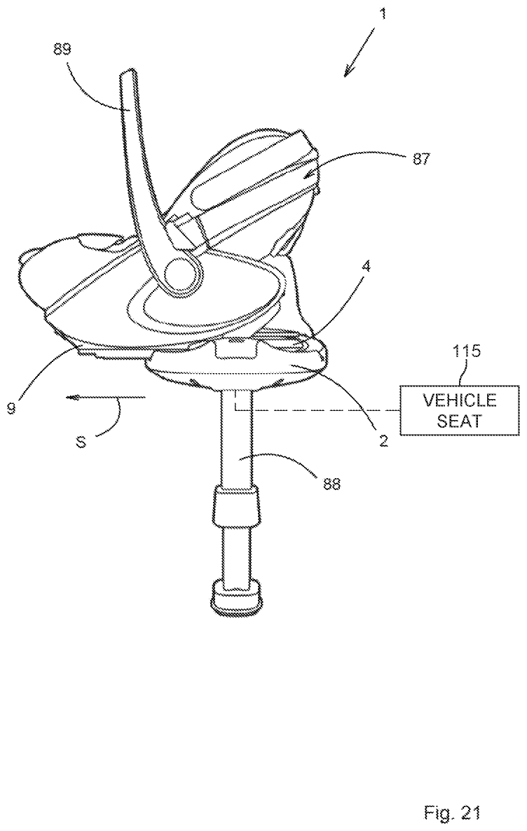

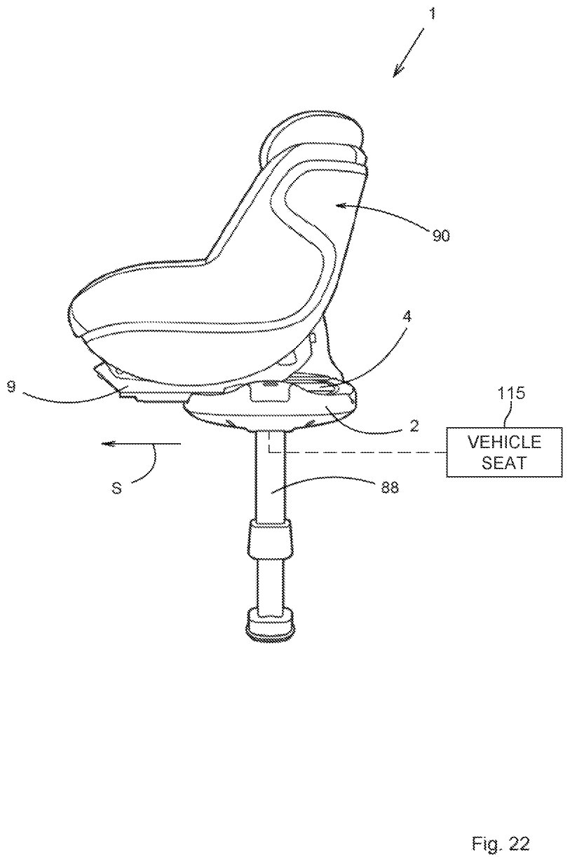

A juvenile restraint 1 according to the present disclosure includes a seat base 2 adapted to be mounted to a vehicle seat 115, a child vehicle seat 87, 90, and a seat-configuration controller 91 for changing a configuration of the child vehicle seat 87, 90 as shown in FIGS. 21-22. The child vehicle seat 87, 90 is adapted to secure a child (not shown) for transportation in a vehicle (not shown). The seat-configuration controller 91 changes the child vehicle seat 87, 90 between a transportation configuration as shown in FIG. 18, a lateral-retracted configuration as shown in FIG. 19, and a lateral-extended configuration as shown in FIG. 20.

In the transportation configuration shown in FIG. 18, the child faces the front or rear of the vehicle. In the lateral-retracted configuration shown in FIG. 19, the child faces a lateral side of the vehicle, such as a passenger side or a driver side. In the lateral-extended configuration shown in FIG. 20, the child vehicle seat 87, 90 is translated towards a door of the vehicle, such as the rear passenger-side door or the rear driver-side door. A caregiver may use the seat-configuration controller 91 to move the child vehicle seat 87, 90 to the lateral-extended configuration so that the child can move into or out of the child vehicle seat 87, 90. The caregiver may also move the child vehicle seat 87, 90 to the lateral-extended configuration so that the caregiver can place or remove the child vehicle seat on or from the seat-configuration controller 91.

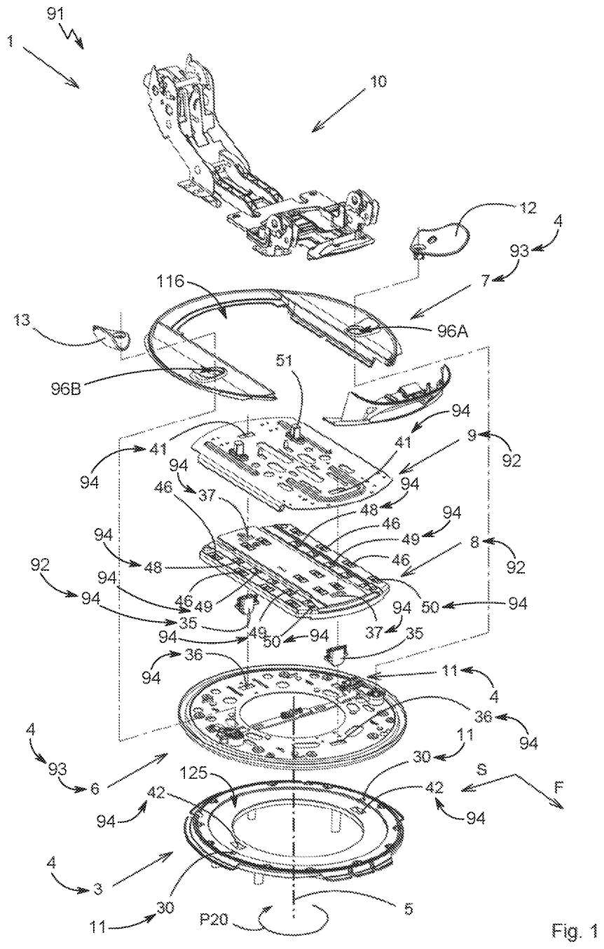

The seat-configuration controller 91 includes a seat mount 10, a seat-pivot unit 4, and a seat-slide unit 92 as shown in FIG. 1. The seat mount 10 couples with the child vehicle seat 87, 90 for movement therewith. The seat-pivot unit 4 rotates the child vehicle seat 87, 90 about a center pivot axis 5 between the transportation configuration and the lateral-retracted configuration. The seat-slide unit 92 slides the child vehicle seat 87, 90 relative to the seat base 2 between the lateral-retracted configuration and the lateral-extended configuration.

In the lateral-extended configuration shown in FIG. 20, the child vehicle seat 87, 90, the seat mount 10, and a first portion of the seat-slide unit 92 extend laterally away from the seat base 2, the seat-pivot unit 4, and a second portion of the seat-slide unit 92. Accordingly, the seat base 2, the seat-pivot unit 4, and the second portion of the seat-slide unit 92 are secure to the vehicle seat while the child is moving into or out of the child vehicle seat 87, 90 or a caregiver is placing or removing the child vehicle seat 87, 90 on or from the seat mount 10.

The seat-pivot unit 4 includes features that selectively allow the child vehicle seat 87, 90 to rotate relative to the seat base 2 to change the child vehicle seat 87, 90 from the transportation configuration to the lateral-retracted configuration and vice versa. The seat-slide unit 92 includes features that selectively allow the child vehicle seat 87, 90 to move laterally relative to the seat base 2 to change the child vehicle seat 87, 90 from the lateral-retracted configuration to the lateral-extended configuration and vice versa.

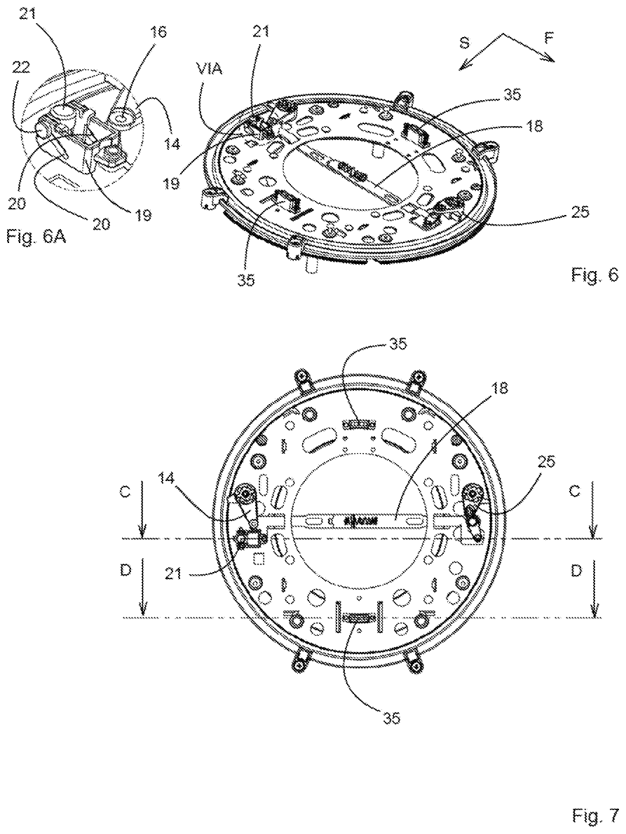

Referring to FIGS. 1-7D, the seat-pivot unit 4 changes the child vehicle seat 87, 90 between the transportation configuration and the lateral-retracted configuration. The seat-pivot unit 4 includes a hub mount 3 coupled to the seat base 2, a pivot hub 93 coupled to the hub mount 3, and a pivot controller 11. The pivot hub 93 rotates relative to the hub mount 3 about the center pivot axis 5. The pivot controller 11 selectively allows rotation of the pivot hub 93 relative to the hub mount 3 to change the child vehicle seat 87, 90 between the transportation configuration and the lateral-retracted configuration.

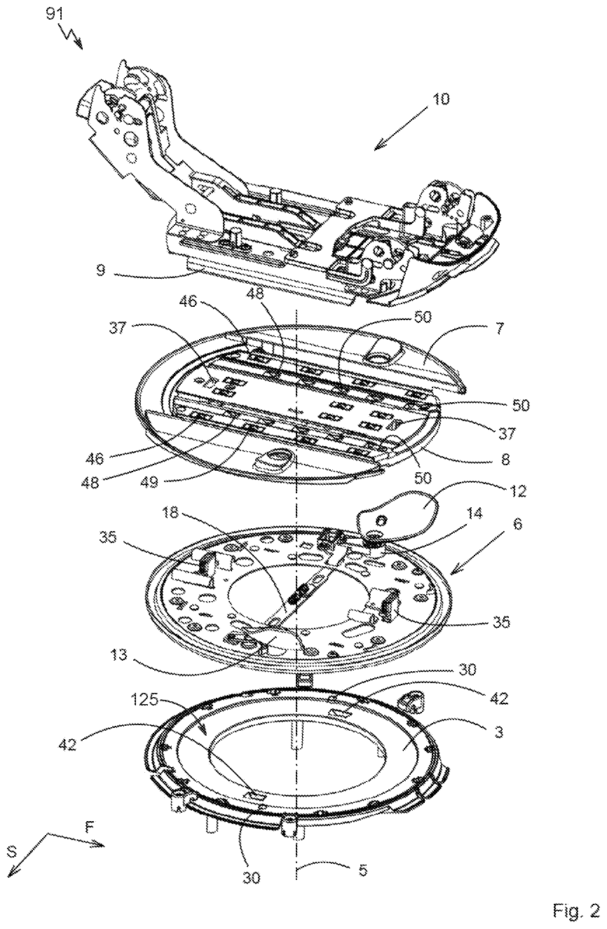

The pivot hub 93 rotates about the center pivot axis 5 relative to the hub mount 3. As shown in FIGS. 1 and 2, the pivot hub 93 includes a bottom plate 6 and a top plate 7. The bottom plate 6 is coupled to the hub mount 3 to rotate about the center pivot axis 5. The top plate 7 is coupled to the bottom plate for rotation therewith. The top plate 7 is also formed to include an aperture 116 that receives the seat-slide unit 92.

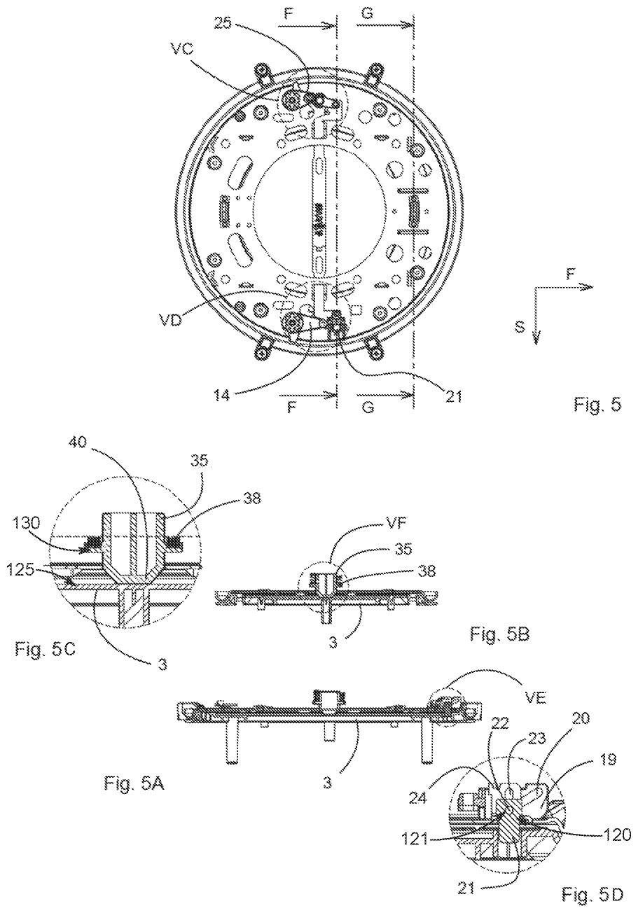

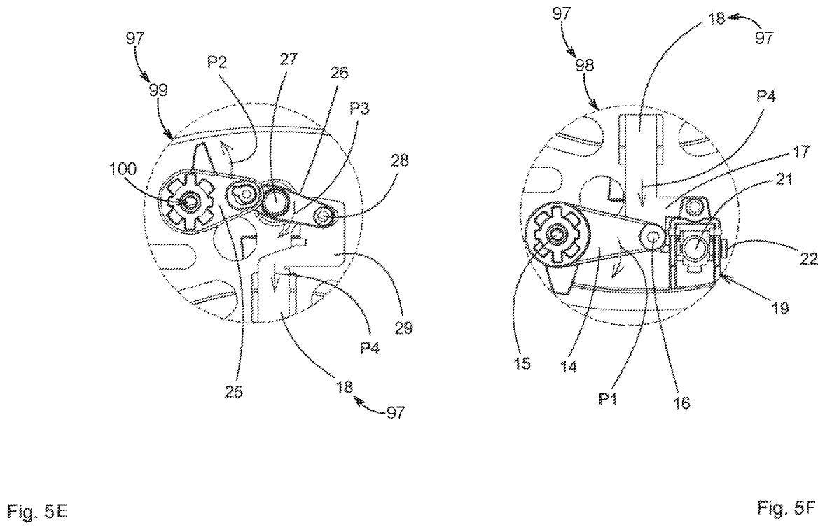

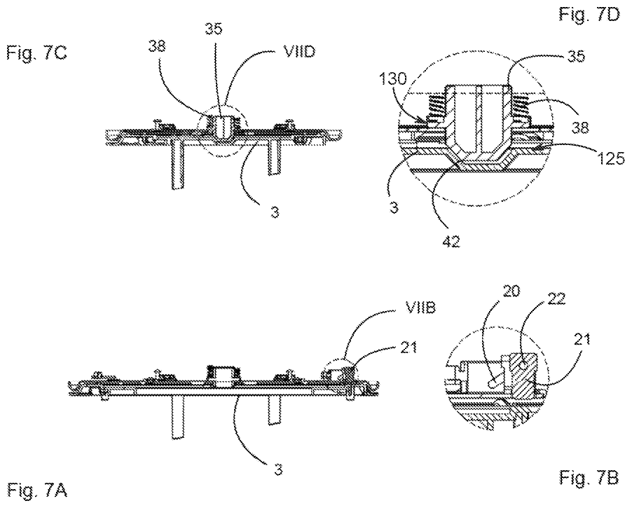

The pivot controller 11 selectively allows rotation of the pivot hub 93 relative to the hub mount 3. As shown in FIGS. 1-7D, the pivot controller 11 includes a pivot lock 101 coupled to the pivot hub 93, a pivot-lock receiver 30 formed in the hub mount 3, and a pivot-lock actuator 97 coupled to the pivot hub 93 to control movement of the pivot lock 101. The pivot lock 101 is movable between a pivot-locked position as shown in FIG. 5D and a pivot-unlocked position as shown in FIG. 7B. In the pivot-locked position, pivot hub 93 is blocked from rotation about the center pivot axis 5 when the child vehicle seat 87, 90 is in the transportation configuration. In the pivot-unlocked position, the pivot hub 93 is allowed to rotate about the center pivot axis 5 to change the child vehicle seat 87, 90 from the transportation configuration to the lateral-retracted configuration. The pivot-lock receiver 30 engages the pivot lock 101 in the pivot-locked positon. The pivot-lock actuator 97 moves the pivot lock from the pivot-locked position to the pivot-unlocked position.

The pivot lock 101 includes a bracket 24 fixed to the bottom plate 6 of the pivot hub 93, a pin 95 that engages the pivot-lock receiver 30 when the pivot lock 101 is in the pivot-locked position, and a pin driver 19 coupled to the pivot-lock actuator 97 and the pin 95. The bracket 24 is formed to include vertically-extending slots 23 spaced apart to define a pin-receiving space 117 between the vertically-extending slots 23. The pin 95 is positioned in the pin-receiving space 117. The pin driver 19 moves toward a lateral side the bottom plate 6 upon actuation of the pin driver 19 by the pivot-lock actuator 97. As the pin driver 19 moves toward the lateral side of the bottom plate 6, the pin 95 moves upward relative to the vertically-extending slots 23 away from the pivot-lock receiver 30 to change the pivot lock 101 from the pivot-locked position to the pivot-unlocked position.

The bracket 24 includes a first wall 118 formed to include a first vertically-extending slot 23A of the vertically-extending slots 23 and a second wall 119 formed to include a second vertically-extending slot 23B of the vertically-extending slots 23. The first wall 118 and the second wall 119 are spaced apart from each other and cooperate to form the pin-receiving space 117 there between.

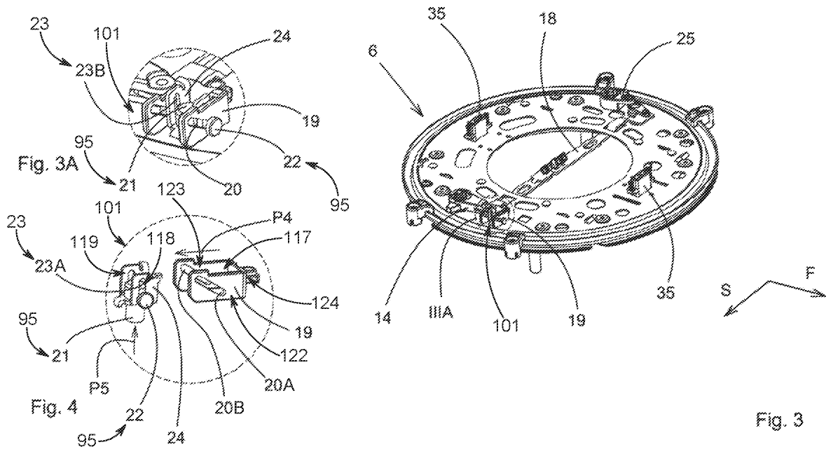

The pin 95 includes a lock pin 21 and a drive pin 22 as shown in FIGS. 3A and 4. The lock pin 21 extends vertically through the pin-receiving space 118, through a lock-pin aperture 120 formed in the bottom plate 6, and into the pivot-lock receiver 30 when the pivot lock 101 is in the pivot-locked position as shown in FIG. 5D. The lock pin 21 is formed to include a drive-pin aperture 121 to receive the drive pin 22. Accordingly, the drive pin 22 is coupled to the lock pin, the pin driver, and extends through the vertically-extending slots 23 of the bracket 24. Upon actuation of the pin driver 19 by the pivot-lock actuator 97, the vertically-extending slots 23 guide the drive pin 22 upward to move the lock pin 21 upwardly away from the pivot-lock receiver 30 so that the pivot lock 101 is in the pivot-unlocked position as shown in FIG. 7B.

The pin driver 19 includes a first wall 122, a second wall 123 spaced apart from the first wall, and a rod wall 124 extending between and interconnecting the first wall 122 and the second wall 123. As shown in FIG. 3A, at least some of the bracket 24 is located between the first wall 122 and the second wall 123. The rod wall 124 is also coupled to the pivot-lock actuator 97.

The first wall 122 is formed to include a first angled slot 20A that extends laterally and vertically relative to the vertically-extending slots 23. Likewise, the second wall 123 is formed to include a second angled slot 20B that extends laterally and vertically relative to the vertically-extending slots 23. The first and second angled slots 20A, 20B receive the drive pin 22 to couple the drive pin 22 to the pin driver 19. Upon actuation of the pin driver 19 by the pivot-lock actuator 97, the first and second angled slots 20A, 20B guide the drive pin 22 upward and laterally while the vertically-extending slots 23 guide the drive pin upward to move the lock pin 21 upwardly away from the pivot-lock receiver 30 so that the pivot lock 101 is in the pivot-unlocked position.

The pivot-lock actuator 97 causes the pivot lock 101 to move from the pivot-locked positon to the pivot-unlocked position. The pivot-lock actuator 97 includes a first pin release 98, a second pin release 99, and a longitudinal rod 18 interconnecting the first pin release 98 and the second pin release 99 as shown in FIG. 3. The first pin release 98 is coupled to a first lateral side of the bottom plate 6 and the second pin release 99 is coupled to a second lateral side of the bottom plate 6 opposite the first lateral side. The longitudinal rod 18 has a first end 17 coupled to the pivot lock 101 and the first pin release 98 and a second end 29 coupled to the second pin release 99. Accordingly, the pivot lock 101 moves from the pivot-locked position to the pivot-unlocked position upon actuation of one of the first pin release 98 and the second pin release 99.

The first pin release 98 includes a first handle 12 and a first connecting piece 14 as shown in FIG. 5F. The first handle 12 is coupled to the first lateral side of the bottom plate 6 and is rotatable about a first handle pivot axis 15. The first connecting piece 14 is coupled to the first handle 12 and the first end 17 of the longitudinal rod 18. Upon rotation of the first handle 12 about the first handle pivot axis 15, the first connecting piece 14 rotates with the first handle 12. An end 16 of the first connecting piece 14 moves the first end 17 of the longitudinal rod 18 towards the first lateral side of the bottom plate 6 to move the pivot lock 101 from the pivot-locked positon to the pivot-unlocked position. In other words, the actuation of the first handle 12 causes the connecting piece 14 to pull the longitudinal rod 18 towards the first lateral side of the bottom plate 6. This movement of the longitudinal rod 18 causes the pin driver 19 to move the pin 95 out of the pivot-lock receiver 30.

The second pin release 99 includes a second handle 13, a second connecting piece 25, and a lever 26 as shown in FIG. 5E. The second handle 13 is coupled to the second lateral side of the bottom plate 6 and is rotatable about a second handle pivot axis 100. The second connecting piece 25 is coupled to the second handle 13 and the lever 26. The lever 26 is coupled to the second connecting piece 25 and the second end 29 of the longitudinal rod 18. Upon rotation of the second handle 13 about the second handle pivot axis 100, the second connecting piece 25 rotates with the second handle 13. The second connecting piece 25 also causes the lever 26 to rotate about a lever pivot axis 27. An end 28 of the lever 26 moves the second end 29 of the longitudinal rod 18 towards the first lateral side of the bottom plate 6 to move the pivot lock 101 from the pivot-locked position to the pivot unlocked position. In other words, the actuation of the second handle 13 causes the lever 26 to push the longitudinal rod 18 towards the first lateral side of the bottom plate 6. This movement of the longitudinal rod 18 causes the pin driver 19 to move the pin 95 out of the pivot-lock receiver 30.

As shown in FIG. 1, the top plate 7 is formed to include a first handle-receiving aperture 96A on a first lateral side of the top plate 7 and a second handle-receiving aperture 96B on a second lateral side of the top plate 7. The handle-receiving apertures 96A, 96B receive the handles 12, 13 to couple the top plate 7 to the bottom plate 6 and allow access to the handles 12, 13 by a caregiver.

Referring to FIGS. 1-3, the seat-slide unit 92 includes an arm frame 8, a slidable arm 9, and a slide controller 94. The arm frame 8 is coupled to the bottom plate 6 for movement therewith. The slidable arm 9 movable relative to the arm frame 8. The slide controller 94 blocks movement of the slidable arm 9 relative to the arm frame 8 when the child vehicle seat 87, 90 is in the transportation configuration. In addition, the slide controller 94 guides movement of the slidable arm 9 relative to the arm frame 8 when the child vehicle seat 87 is in the lateral-retracted configuration and the lateral-extended configuration.

The slide controller 94 includes a slide lock 35, an upper slide-lock receiver 41 formed in the slidable arm 9, and a lower slide-lock receiver 42 formed in the hub mount 3. The slide lock 35 is movable between a slide-locked position suggested in FIG. 5C and a slide-unlocked position suggested in 7C. In the slide-locked position, the slidable arm 9 is blocked from moving relative to the arm frame 8 when the child vehicle seat 87, 90 is in the transportation configuration. In the slide-unlocked position, the slidable arm 9 is allowed to move relative to the arm frame 8 when the child vehicle seat is in one of the lateral-retracted configuration and the lateral-extending configuration. The upper slide-lock receiver 41 receives the slide lock 35 in the slide-locked position, while the lower slide-lock receiver 42 receives the slide lock 35 in the slide-unlocked position.

The lower slide-lock receiver 42 extends downwardly away from an upper surface 125 of the hub mount 3 as shown in FIGS. 2 and 7D. When the slide lock 35 is in the slide-locked position, a lower end 40 of the slide lock 35 engages the upper surface 125 of the hub mount 3 such that an upper end 126 of the slide lock 35 engages the upper slide-lock receiver 41 to block movement of the slidable arm 9 relative to the arm frame 8. When the slide lock 35 is in the slide-unlocked positon, the lower end 40 of the slide lock 35 engages the lower slide-lock receiver 42 and disengages from the upper slide-lock receiver 41 to allow movement of the slidable arm 9 relative to the arm frame 8.

The slide controller 94 further includes a first slide-lock guide 37 formed in the arm frame 8 and a second slide-lock guide 36 formed in the bottom plate 6. The slide-lock guides 37, 36 guide the slide lock 35 between the slide-locked position and the slide-unlocked position.

The slide lock 35 includes a lock body 129 and a bias member 38. The lock body 129 includes the upper end 126, the lower end 40, and a stop 130 located between the upper end 126 and the lower end 40. The upper end 40 is received in the first slide-lock guide 37 in both the slide-locked position and the slide-unlocked position, and is received in the upper slide-lock receiver 41 in the slide-locked position. The lower end 40 is received in the second slide-lock guide 36 in both the slide-locked position and the slide-unlocked position, and is received in the lower slide-lock receiver 42 in the slide-unlocked position. The stop 130 blocks the upper end 126 from being received in the second slide-lock guide 36. The bias member 38 is positioned between the stop 130 and the arm frame 8 to apply a bias force that urges the lower end 40 downward towards the lower slide-lock receiver 42.

A caregiver moves the slide lock 35 from the slide-unlocked positon in which the lower end 40 engages the lower slide-lock receiver 42 to the slide-locked position in which the upper end 126 engages the upper slide-lock receiver 41 by applying a predetermined force to the slide lock 35 that overcomes the bias force. The predetermined force applied to the slide lock 35 allows for the lower end 40 to slide out of the lower slide lock-receiver 42 and engage the upper surface 125 to push the upper end 126 into the upper slide-lock receiver 41.

In the illustrative embodiment, the slide controller 94 includes two slide locks 35, two lower slide-lock receivers 42, two upper slide-lock receivers 41, and two first and second slide-lock guides 37, 36 located on opposite lateral sides of the seat-pivot unit 4 and the seat-slide unit 92. However, in other embodiments, the slide controller 94 may have only one slide lock 35, lower slide-lock receiver 42, upper slide-lock receiver 41, and first and second slide-lock guides 37, 36.

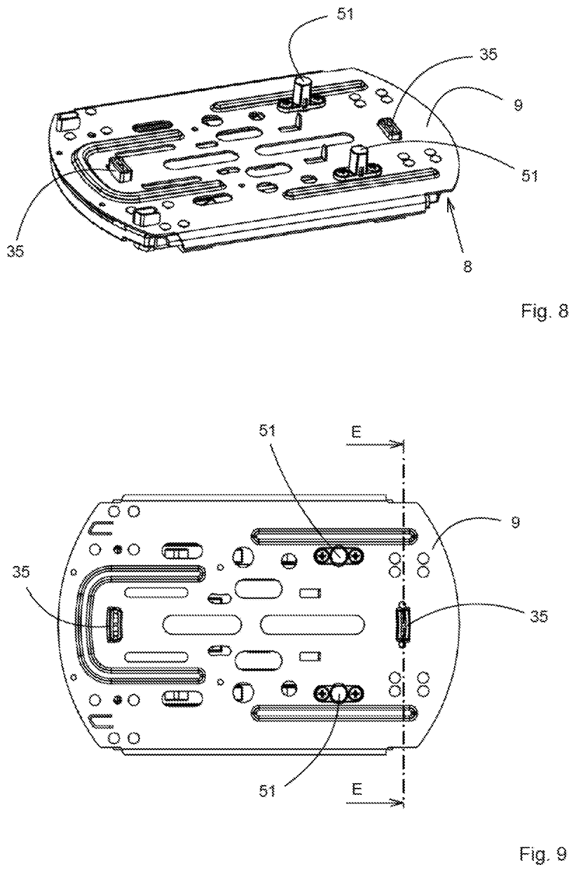

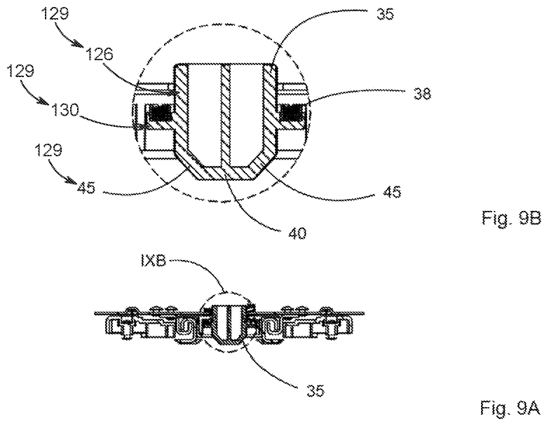

As explained above, the slide controller 94 also guides movement of the slidable arm 9 relative to the arm frame 8. When the slide lock 35 is in the slide-unlocked position, the slidable arm 9 is movable between a retracted position, an extended position, and one or more intermediate positions between the retracted positon and the extended position, as suggested in FIGS. 8-14A. Accordingly, the slide controller 94 guides movement of the slidable arm 9 between the retracted position, the extended position, and the one or more intermediate positions.

When the slidable arm 9 is in the retracted position, the child vehicle seat 80, 97 may be in the lateral-retracted configuration. When the slidable arm 9 is in the extended position, the child vehicle seat 80, 97 may be in the lateral-extended configuration. When the slidable arm 9 is in the one or more intermediate positions, the child vehicle seat 80, 97 is being moved between the lateral-retracted configuration and the lateral-extended configuration.

The slide controller 94 further includes retainers 48, 49, 50 formed in the arm frame 8 and a soft lock 127 coupled to the slidable arm 9. The soft lock 127 extends between the slidable arm 9 and the arm frame 8 to engage with one of the retainers 48, 49, 50 when the slidable arm 9 is in one of the retracted position, the extended position, and the one or more intermediate positions. In some embodiments, the slide controller 94 may have only one retainer 48 formed in the arm frame 8 to engage the soft lock 127 when the slidable arm 9 is in the retracted position.

The soft lock 127 includes a pin 52 extending downwardly away from the slidable arm 9 and a bias member 53 located between the slidable arm 9 and the pin 52. The bias member 53 applies a bias force that urges the pin downward towards the retainers 48, 49, 50. A caregiver moves the slidable arm 9 from one of the retracted position, the extend position, and the one or more intermediate positons to another one of the retracted position, the extended position, and the one or more intermediate positions by applying a predetermined force to the pin 52 that overcomes the bias force. The predetermined force applied to the pin 52 allows for the pin 52 to disengage from one of the receivers 48, 49, 50 so that the caregiver can move the slidable arm 9 to another one of the retracted position, the extended position, and the one or more intermediate positions.

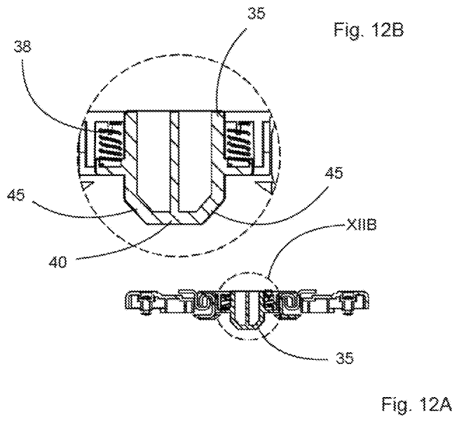

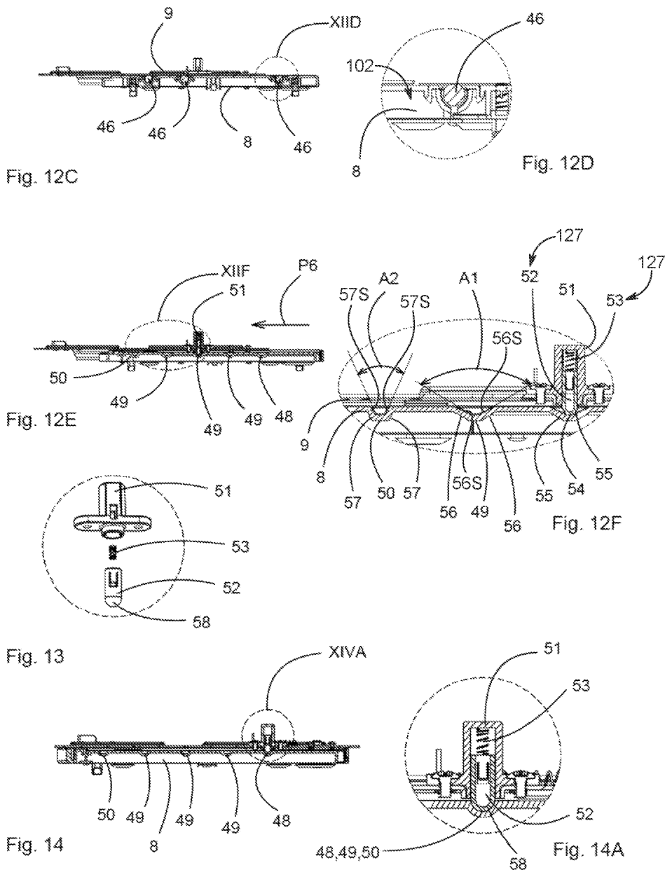

As shown in FIG. 12F, the retainers 48 and 50 are end retainers and the retainers 50 are intermediate retainers. The end retainers 48, 50 are each formed to include inclined walls 57 that define a first angle A1 between inclined surfaces 57S of the inclined walls 57 that face each other The intermediate retainers 50 are formed to include inclined walls 56 that define a second angle A2 between the inclined surfaces 56S of the inclined walls that face each other. The second angle A2 is greater than the first angle A1. Accordingly, a first predetermined force applied to the pin 52 to overcome the bias force to remove the pin 52 from one of the end retainers 48, 50 and move the slidable arm from the retracted position or the extended position is greater than a second predetermined force applied to the pin 52 to overcome the bias force to remove the pin 52 from one of the intermediate retainers 50 and move the slidable arm from one of the one or more intermediate positions. In some embodiments, the slide controller 94 may have only one intermediate retainer 50.

In the illustrative embodiment, the slide controller 92 includes retainers 48, 49, 50 on separate lateral sides of the arm frame 8 and soft locks 127 on the separate lateral sides of the slidable arm 9 to encourage even movement of the slidable arm 9. In other embodiments, the slide controller 92 may include the retainers 48, 49, 50 and one soft lock 127 on only one lateral side or the center of the arm frame 8 and the slidable arm 9.

As shown in FIG. 1, the arm frame 8 includes a frame plate 102 and bearings 46 coupled to the frame plate 102. The bearings 46 engage the slidable arm 9 to encourage movement of the slidable arm 9 relative to the arm frame 8.

The seat mount 10 includes a seat retainer 106, a retainer-rotation stop 109, and a stop release 112. The seat retainer 106 engages the child vehicle seat 80, 97. The retainer-rotation stop 109 blocks movement of portions of the seat retainer 106 which engage the child vehicle seat 80, 97. The stop release 112 moves the retainer-rotation stop 109 away from the seat retainer to allow movement of portions of the seat retainer 106.

The seat retainer 106 includes a rear retainer unit 107 that engages a rear end of the child vehicle seat 80, 97 and a front retainer unit 108 that engages a front end of the child vehicle seat 80, 97. The rear retainer unit 107 includes a rear support 61 coupled to the slidable arm 9 and rear retainers 63 that engage the rear end of the child vehicle seat 80, 97. The rear retainers 63 are biased to rotate about a rear pivot axis 64 in a first direction P7 opposite the rear end of the child vehicle seat 80, 97. The front retainer unit 108 includes a front support 62 coupled to the slidable arm 9 and front retainers 65 that engage a front end of the child vehicle seat 80, 97. The front retainers 65 are biased to rotate about a front pivot axis 66 in a second direction P8 opposite of the first direction P7 and opposite the front end of the child vehicle seat 80, 97.

The rear retainers 63 are each formed to include a recess 67 that receives a rear attachment rod (not shown) of the rear end of the child vehicle seat 80, 97 and a stop-engagement surface 73 that engages with the retainer-rotation stop 109. The front retainers 65 are each formed to include a recess 67 that receive a front attachment rod (not show) of the front end of the child vehicle seat 80, 97 and a stop-engagement surface 82 that engages with the retainer-rotation stop. In some embodiments, the rear retainer unit 107 may only have one rear retainer 63 or more than 2 rear retainers 63, and the front retainer unit 108 may only one rear retainer 65 or more than 2 front retainers 65.

The retainer-rotation stop 109 includes a rear retainer-block unit 110, a front retainer-block unit 111, and a bias member 71. The rear retainer-block unit 110 blocks rotation of rear retainers 63 in the first direction P7. The front retainer-block unit 111 blocks rotation of the front retainers 65 in the second direction P8. The bias member 71 urges the rear retainer-block unit 110 and the front retainer-block unit 111 to block rotation of the rear retainers P7 in the first direction and the front retainers in the second direction P8.

The rear retainer-block unit 110 includes a rear slide 70 coupled to the rear support and rear rotation-blockers 72 coupled to the rear slide 70. The rear slide 70 moves longitudinally relative to the rear support 61. The rear rotation-blockers 72 selectively engage the stop-engagement surfaces 73 of the rear retainers 63 to block rotation of the rear retainers 63 in the first direction P7. Similarly, the front retainer-block unit 111 includes a front slide 80 coupled to the front support 62 and front rotation-blockers 81 coupled to the front slide 80. The front slide 80 moves longitudinally relative to the front support 62. The front rotation-blockers 81 selectively engage the stop-engagement surfaces 82 of the front retainers 65 to block rotation of the front retainers 65 in the second direction P8. In some embodiments, the rear retainer-block unit 110 may only have one rear-rotation blocker 72 or more than 2 rear rotation-blockers 72, and the front retainer-block unit 111 may only have one front rear-rotation blocker 81 or more than 2 front rear-rotation blockers 81.

The stop release 112 includes one or more levers 75 coupled to and interconnecting the slidable arm 9, the rear slide 70, and the front slide 80, and a release actuator 83, 74. The release actuator 83, 74 overcomes a bias force of the bias member 71 to move the rear slide 70 in a forward direction. The rear slide 70 moving in a forward direction causes the one or more levers 75 to rotate about one or more lever pivot axes 77 to pull the front slide 80 in a rearward direction. Accordingly, the rear rotation-blockers 72 disengage from the rear retainers 63 to allow rotation of the rear retainers 63 in the first direction P7 while the front rotation-blockers 81 disengage from the front retainers 65 to allow rotation of the front retainers 65 in the second direction P8 to release the child vehicle seat 87, 90 from the seat mount 10. The release actuator is a handle 83 that can be pulled by a caregiver in the forward direction to move the rear slide 70 in the forward direction. Additionally or alternatively, the release actuator is an actuation button 74 that can be pressed by a caregiver to cause the rear slide 70 to be pushed in the forward direction.

FIGS. 1-22 show a juvenile restraint 1 according to the present disclosure.

The juvenile restraint 1 comprises a base 2 (see FIGS. 18-22) detachably connectable to a vehicle seat. The base plate 3 is fixed to the base 2.

The juvenile restraint 1 further comprises a rotating part 93 being rotatable with respect to the base 2 about a rotation axis 5 from a forward facing position as shown in FIG. 18 seen in a driving direction F of the vehicle in use to a side facing position as shown in the FIGS. 18, 19 directed to in a sliding direction S towards a door of the vehicle to a rearward facing position and to a side facing position directed to another door of the vehicle. The sliding direction S extends substantially perpendicular to the driving direction F. The rotating part 93 comprises a bottom plate 6 and a top plate 7. A guiding plate 8 is located between the bottom plate 6 and the top plate 7.

The juvenile restraint 1 further comprises a sliding part 9 being slidable with respect to the guiding plate 8. As will be explained here below, the sliding part 9 being slidable with respect to the guiding plate 8 in the sliding direction S, when the rotating part 93 is being rotated to one of the side facing positions directed to one of the doors of the vehicle.

Mounted on top of the sliding part 9 is a mounting element 10 for detachable holding a child seat 87, 90. For the sake of clarity, the child seat 87, 90, also called a child vehicle seat, is not shown in the FIGS. 1-20 but only in the FIGS. 21 and 22.

FIG. 1 shows the base plate 3, the rotating part 93 rotatably connected on top of the base plate 3 and the sliding part 7 being slidable connected on top of the guiding plate 8. The juvenile restraint 1 comprises first locking means 11 to detachably lock the rotating part 93 to the base plate 3 in the forward facing position and the rearward facing position. The juvenile restraint 1 also comprises second locking means to detachably lock sliding of the sliding part 9 with respect to the rotating part 93 and the guiding plate 8.

As will be further explained here below, unlocking of the first locking means 11 enable the rotating part 93 together with guiding plate 8, the sliding part 9, the mounting element 10 and the child seat 87, 90 to rotate about the rotation axis 5. Near or at the side facing positions the second locking means will be automatically unlocked to allow the sliding part 9, the mounting element 10 and the child seat to slide in the sliding direction S.

The first locking means 11 comprises a first and second handle 12, 13 located on opposite sides of the juvenile restraint 1. The handle 12 is provided with a connecting piece 14 being pivotable about pivot axis 15 (FIG. 5F) in a direction indicated by arrow P1. An end 16 of connecting piece 14 is pivotably connected to a first end 17 of a longitudinal rod 18 extending to the other handle 13. Also connected to this first end 17 is a holder 19. The holder 19 is provided with two slots 20 extending under an angle with the vertical and horizontal. A vertically extending locking pin 21 is located between the slots 20. A horizontal pin 22 extends through the locking pin 21 and is slidably located in the slots 20. The horizontal pin is further slidably located in a vertically extending slot 23 of a bracket 24. The bracket 24 is fixed to the bottom plate 6 of the rotating part 93.

As can be seen in FIG. 5E, the handle 13 is provided with a connecting piece 25 being pivotable in a direction indicated by arrow P2. The connecting piece 25 is connected to a lever 26. The lever 26 is pivotable about a pivot axis 27 in a direction indicated by arrow P3. An end 28 of the lever 26 is pivotably connected to a second end 29 of the longitudinal rod 18 extending to the other handle 12.

By actuating the handle 12 or the handle 13, the connecting pieces 14, 25 connected thereto will also be pivoted due to which the longitudinal rod 18 will be moved in the direction as indicated by arrow P4. When moving the longitudinal rod 18 in the direction as indicated by arrow P4, the holder 19 will be moved in this direction as well. The horizontal pin 22 will slide in the slots 20 in upward direction as indicated by arrow P5 whereby the vertically extending locking pin 21 will be moved upwardly as well. Before moving upwardly, the end of the locking pin 21 is located in one of two locking holes 30 of the base plate 3, thereby locking the rotating part 93 to the base plate 3. By moving the locking pin 21 out of the locking hole 30, the rotating part 93 is being unlocked from the base plate 3 and can be rotated about the rotation axis 5 in the direction as indicated by arrow P20.

One of the locking holes 30 is used to lock the rotating part 93 to the base plate 3 in a forward facing position of the child seat whilst the other locking hole 30 is being used to lock the rotating part 93 to the base plate 3 in a rearward facing position of the child seat.

The second locking means comprises two engagement elements 35 extending through openings 36 in the bottom plate 6 and the openings 37 in the guiding plate 8. The engagement elements 35 are pressed in the direction of the base plate 3 by means of springs 38, whereby the bottom 40 of the engagement element 35 is located against the baseplate 3. Upper parts of the engagement elements 35 are located in engagement holes 41 of the sliding part 9 thereby locking the sliding part 9 to the bottom plate 6 and the guiding plate 8.

When the rotating part 93 is being rotated with respect to the base plate 3, the bottom 40 of the engagement elements 35 will slide over the base plate 3 until the engagement elements 35 will reach engagement holes 42 of the base plate 3. As soon as the engagement elements 35 reach the engagement holes 42 of the base plate 3, the engagement elements 35 will be moved under spring force of springs 38 into the engagement holes 42, thereby locking the rotating part 93 to the base 93, moving out of the engagement holes 41 of the sliding part 9 and unlocking the sliding part 9 from the rotating part 93.

The rotating part 93 will be locked to the base plate 3 in a position whereby the child seat is in one of the two side facing directions.

In the shown embodiment, the engagement elements 35 are located opposite to each other in a line being substantially perpendicular to the longitudinal rod 18. Due to this orientation, the locking holes 30 and the engagement holes 42 of the base plate 3 are located closely together. However, other arrangements are also possible.

In the shown embodiment the engagement holes 42 have the same dimensions as the bottom 40 of the engagement elements 35 so that the engagement element 35 fits nicely in the engagement hole 42. Sides of the bottom 40 are provided with sloped parts 45 as are the engagement holes 42. Due to the sloped parts 45 the engagement elements 35 can easily be moved out of the engagement holes 42 against spring force of the springs 38 when the rotating part 93 is being rotated again with respect to the base 2.

If desired the engagement hole 42 may be longer in the direction of rotation of the rotating part 93 than the engagement element 35 so that the rotating part 93 can slightly rotate with respect to the base 2 in the side facing position over a predetermined angle being between 0 and 20 degrees, more preferably 10 degrees.

The guiding part 8 is provided with bearings 46, see FIGS. 12C and 12D to facilitate the sliding of the sliding part 9 with respect to the guiding part 8, the bearings 46 can be ball bearings or roller bearings. Due to the bearings 46 the force to move the sliding part 9 with respect to the guiding part 8 is relative low which is very convenient during sliding of the sliding part 9.

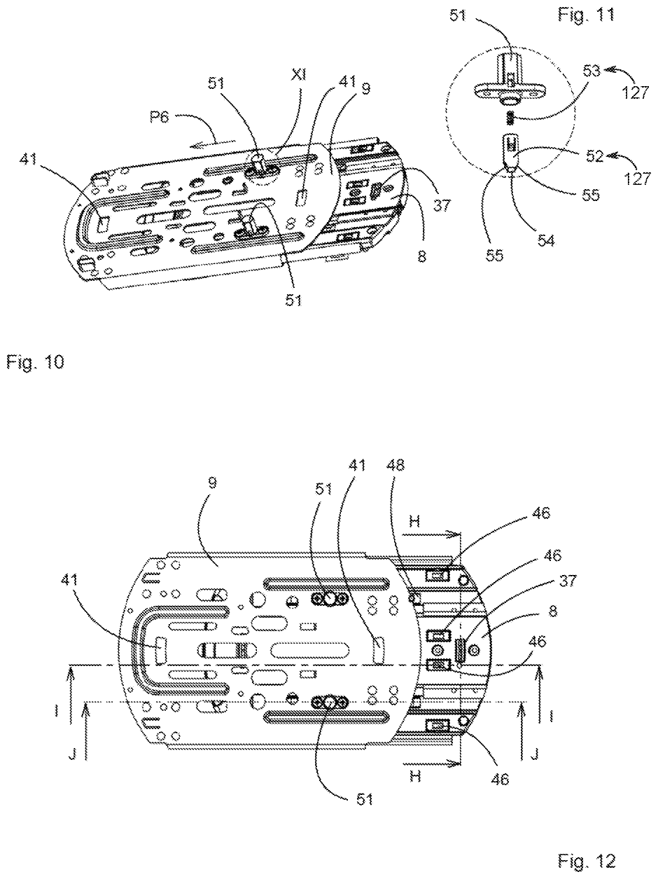

However, when a parent wants to remove the child from the child seat, remove the child seat from the mounting element 10 or place the child back into the child seat or place the child seat back onto the mounting element 10 a more firm connection between the sliding part 9 and the guiding part 8 would be appreciated so that the sliding part 9 will not or nearly not move with respect to the guiding part 8. Such a more firm connection is realized by the child seat at a start position as shown in FIG. 8, a number of intermediate positions (one as shown in FIGS. 10, 12) and an end position of the sliding part 9 with respect to the guiding part 8. The end position is the position wherein the sliding part 9 has slid as far as possible with respect to the guiding part 8. At the start position the sliding part 9 is located completely above the guiding part 8.

To define the start position, in this embodiment three intermediate positions and the end position, the guiding plate 8 is at each position provided with two rows of dents 48, 49, 50 (seen in FIGS. 1, 2). The dents 48 define the start position, the dents 49 the three different intermediate positions and the dents 50 the end positions.

More or less intermediate positions can be realised by removing or covering dents or by adding dents.

To softly lock the sliding part 9 with respect to the guiding part 8 at the dents 48, 49, 50, the sliding part 9 is provided with two holders 51 mounted on top of the sliding part 9. Each holder 51 comprises a pin 52 and a spring 53 located between a top of the pin 52 and the holder 51. The lower end of the pin 52 rests under spring force of the spring 53 against the top surface of the guiding part 8 and is located on a line extending through the dents 48, 49, 50.

By the embodiment as shown in FIGS. 11, 12E, 12F, the lower end 54 of the pin 52 comprises on two opposite sides inclined surfaces 55 so that the lower end 54 is frustoconical shaped. By the embodiment of as shown in FIGS. 12E, 12F the dents 49 at the intermediate positions have inclined surfaces 56 defining an angle A1 between them, whilst the dent 48, 50 at the start and end positions have inclined surfaces 57 defining an angle A2 between them, whereby angle A2 is smaller than angle A1. So the dents are frustoconical shaped. When moving the sliding part 9 with respect to the guiding part 8 in or opposite to the direction as indicted by arrow P6, the lower end 54 will slide over the top surface of the guiding part 8 until the lower end 54 will reach a dent 48, 49, 50, whereby the pin 52 will be moved under spring force of spring 53 into the dent 48, 49, 50. When a person pushes or pulls on the sliding part 9 with a relatively low force, the pins 52 located in the corresponding dents 48, 49, 50 will prevent the sliding part 9 to slide with respect to the guiding part 8. However, as soon as the person pushes or pulls on the sliding part 9 with a larger force, thereby overcoming the predetermined spring force of springs 53, the inclined surfaces 55 of the pins 52 will slide over the incised surfaces 56, 57 of the dents 49, 50. It will be more difficult to move the pins 52 out of the dents 50 with the smaller angle A1 than out at the dents 49 with the larger angle A1. The angles A1, A2 are preferably between 60-140 degrees and other suitable angles may be used. It is also possible to have the same angle A1, A2 at each dent 48, 49, 50. It is also possible to have different angles with respect to the vertical on the opposite side of a dent so that moving in one direction uses a larges initial force than moving in an opposite direction.

By the embodiment as shown in FIGS. 13, 14, 15, the lower end 54 of the pin 52 has a rounded end 58 being located in a hemisphere shaped dent 48, 49, 50. The working of this embodiment is the same as the above described embodiment with the frustoconical shaped lower ends of the pins and frustoconical shaped dents. The force used to remove the pins out of the dents and the feeling when the pins enter the dents will differ.

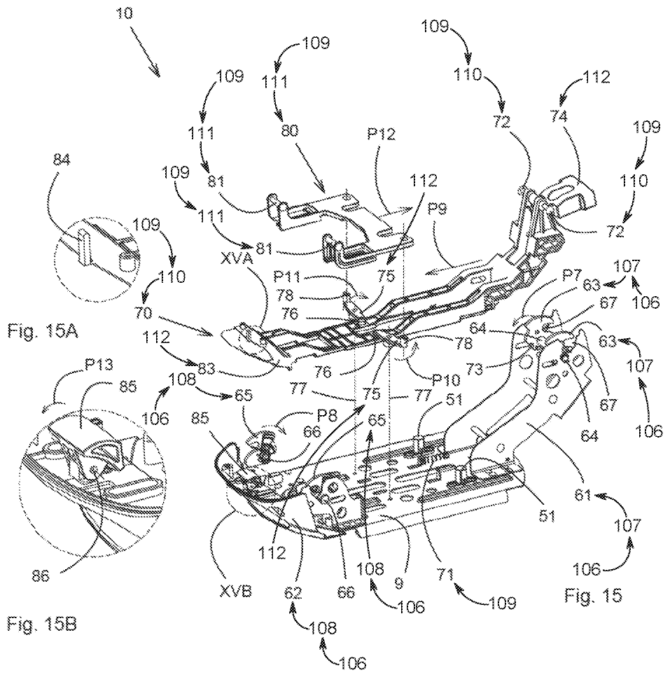

FIGS. 15-17 show the mounting element 10 of the juvenile restraint 1. The mounting element 10 comprises three main parts as shown in FIG. 15. The lower part is mounted on the sliding part 9. It comprises a rear part 61 and a front part 62. The rear part 61 comprises two hooks 63 being pivotable under spring force in the direction as indicated by arrow P7 about pivot axes 64. The front part 62 comprises two hooks 65 being pivotable under spring force in the direction as indicated by arrow P8 about pivot axes 66. The hooks 63 pivot in opposite direction to the hooks 65. Each hook 63, 65 comprises a recess 67 to receive a rod mounted on the lower side of the child seat. Such suitable rods may be used and not shown here.

A middle part forms a slide 70 being slidable in and opposite to the direction as indicated by arrow P9. The slide 70 is pressed under spring force of spring 71 in the direction opposite to arrow P9. At a rear end the slide 70 is provided with two pins 72 being in abutment with surfaces 73 of the hooks 63 when the hooks 63 are being moved against spring force in the direction opposite to arrow P7. The slide 70 is at the rear end also provided with an actuation button 74 to be actuated to push the slide 70 in the direction as indicated by arrow P9.

At the centre the slide 70 is proved with two levers 75, each lever 75 being pivotable connected at one end 76 to the slide 70, in the middle pivotable about pivot axis 77 connected to the sliding part 9 and at the other end 78 pivotable connected to an additional slide 80.

The additional slide 80 forms the third and upper part. At a front end the additional slide 80 is provided with two pins 81 being in abutment with surfaces 82 of the hooks 65 when the hooks 65 are being moved against spring force in the direction opposite to arrow P8.

When the slide 70 is being moved in the direction indicated by arrow P9, the levers 75 will pivot about the pivot axes 77 in the direction as indicated by arrows P10, P11, thereby forcing the additional slide 80 to slide in the direction as indicated by arrow P12. By moving the slide 70 and the additional slide 80, the pins 72, 81 will no longer be in contact with the surfaces 73, 82 and the hooks 63, 65 will move under spring force in the direction indicated by arrows P7, P8, thereby releasing the pins of the child seat. Subsequently, the child seat can be removed from the mounting element 10.

The slide 70 can be moved in the direction indicated by arrow P9, either by pushing on the actuation button 74 at the rear side of the child vehicle seat 87, 90 or pulling on a handle 83 of the slide 70 at the front side of the child vehicle seat 87, 90.

At the front side of the slide 70 at least one vertically extending rod 84 is located. The rod 84 cooperates with an indication knob 85. The indication knob 85 is pivotable about a pivot axis 86 against spring force in the direction as indicated by arrow P13 by rod 84.

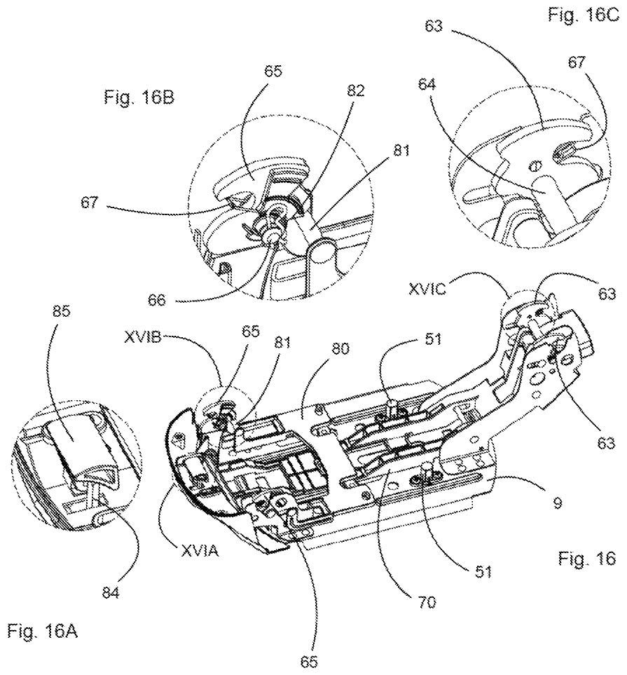

When the hooks 63, 65 are in a closed position (see FIG. 16-16C) receiving the rods of the child seat in the recesses 67 a part of the indication knob 85 is visible through an opening in a cover (not shown) of the child vehicle seat, having for example a green colour. The green colour indicates that all the hooks are closed.

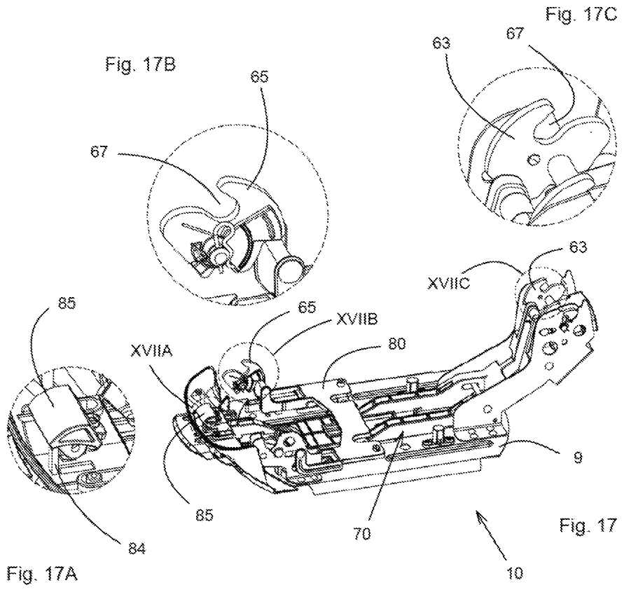

When the hooks 63, 65 are in an open position (see FIG. 17-17C), releasing the rods of the child seat from the recesses 67 another part of the indication knob 85 is visible through an opening in the cover (not shown) of the child vehicle seat, having for example a red colour. The red colour indicates that the hooks are not closed.

During an impact event, the slide 70 wants to move forward with respect to the sliding part 9 due to inertia, whereby the hooks 63 might undesirably release the child seat. Due to the fact that in such a case the additional slide 80 will also moves forward due to inertia, it will keep the hooks 65 and thus also the hooks 63 closed. Both the weight of both movable parts as well as the dimensions of the levers 75 will define this balance so that in case of a crash the hooks 63, 65 will be kept closed.

FIG. 21 shows a front view of the juvenile restraint 1 seen in a direction opposite to the driving direction of the vehicle with a first kind of child seat 87. The child seat 87 is in a side facing position. The child seat 87 is detachable connected to the sliding part 9. The sliding part 9 is located on top of the rotating part 93. The rotating part 93 is located on top of the base 2. The base 2 is provided with a support leg 88 resting with its lower end on a floor of the vehicle. The child seat 87 can be lifted of the sliding part 9 by means of a handle 89. At the bottom side the child seat 87 is provided with rods cooperating with the hooks 63, 65 as described above.

FIG. 22 shows a front view of the juvenile restraint 1 seen in a direction opposite to the driving direction of the vehicle with a second kind of child seat 90. The child seat 90 is in a side facing position. The child seat 90 can be detachable connected or being fixed to the sliding part 9. The sliding part 9 is located on top of the rotating part 93. The rotating part 93 is located on top of the base 2. The base 2 is provided with a support leg 88 resting with its lower end on a floor of the vehicle. In case that the child seat 90 is removable connected to the sliding part 9, the bottom side of the child seat 90 is provided with rods cooperating with the hooks 63, 65 as described above. In such a case both the child seat 87 and the child seat 90 can be used in the same juvenile restraint 1.

Since the child seat 90 is intended for larger children, whereby the child can leave the child seat 90 by itself so that it is also possible to have the child seat 90 being fixed to the slide 9. This has the advantage that no mechanism with hooks 63, 65 is needed but has the disadvantage that the child seats 87, 90 cannot be exchanged.

It is also possible to use the bearing elements by other embodiments of child vehicle seats whereby for example the rotating part is mounted on top of the sliding part.

It is also possible to have the dents on the sliding part and the pin cooperating mounted with the dents on the guiding part.

It is also possible to use other suitable first locking elements.

It is also possible to have engagement holes at, for example 45 degrees, in each direction seen from the forward facing direction. This might be advantageous by vehicles comprising only two front doors and no rear doors. By locking the rotating part at 45 degrees, the sliding part and the child seat attached thereto can be moved in the direction to the nearest front door.

It is also possible to use the first locking element to lock the rotating part to the base for example in the side facing position or in the 45 degrees positions.

It is also possible to use the mechanism for let the sliding part overcome a predetermined force before being able to slide from its current position to a next position, by other sliding parts of child vehicle seats, for example not provided with a rotating part.

It is also possible that the child seat is fixed to the sliding part and cannot be removed thereof.

It is also possible to let the hooks 63, 65 rotate in the same direction in which all the hooks can be opened at the same time by moving of the slide 70.

It is also possible to use the unlocking means located on the front side as well as on the rear side of the child vehicle seat, by other kind of child vehicle seats not provided with a rotating part and/or a sliding part.

It is also possible to use the movable part and/or the additional movable part by other kind of child vehicle seats not provided with a rotating part and/or a sliding part.

A comparative juvenile restraint comprises in one embodiment, a base unit that may be secured to a vehicle seat, a coupling unit extendably and retractably coupled to the base unit, and a safety seat pivotally and removably coupled to the coupling unit. The safety seat may be rotated to face a door entry of the vehicle allowing direct access to the front of the safety seat. Further, the safety seat may be extended toward the door entry of the vehicle, thereby shortening the distance the person loading the child bends or extends to safely place the child in the safety seat. By rotating and extending the safety seat, the handling of the child is simplified and decrease the likelihood of mishandling the child or causing injury to the person loading the child. The safety seat may then be retracted back to a position over the base unit and locked into place, and the safety seat may be rotated toward the front or back of the vehicle and locked into place providing a secured safety seat for the child.

A disadvantage of the comparative juvenile restraint is that the safety seat can also be rotated when being extended towards the door entry. This means that the part being located to the door entry comprises a rotating mechanism, which adds weight to part being extended towards the door entry. A disadvantage of the added weight is that the child vehicle seat will pivot relatively easily in the direction of the door about an axis extending parallel to the driving direction of the vehicle.

Another disadvantage is that the rotating mechanism may conflict with vehicle interior part, such as wheel arches or side parts of the backrest of the vehicle.

Another disadvantage is that the coupling unit can be moved for example partly towards the door entry, without the safety seat being rotated towards the door entry. This has the risk that since the child sitting in the safety seat is still looking in a forward facing or rearward facing direction, that a parent is not aware that the safety seat child is not in the correct and locked position for being used when driving the vehicle.

Another disadvantage is that the rail portions and linear slots will always extend perpendicular to the driving direction of the vehicle. This means that during an impact event, forces will be exerted on the rail portions and linear slots in a direction perpendicular to the driving direction of the vehicle so that the rail portions and linear slots needs to be relatively thick and heavy to be able to absorb these forces. The comparative juvenile vehicle seat is therefor provided with a higher attachment strap which is released every time that a parent wants to rotate the child seat.

The juvenile restraint of the present disclosure provides a child vehicle seat whereby less pivoting force is exerted on the base when the child seat is being moved towards the door of the vehicle.

The juvenile restraint of the present disclosure includes a child seat and the sliding part that are slidable together with respect to the rotating part. The juvenile restraint comprises first locking means to detachably lock the rotating part to the base in the at least forward facing position or rearward facing position, as well as second locking means to detachably lock sliding of the sliding part with respect to the rotating part.

Since the sliding part is mounted on top of the rotating part, the rotating part will only be rotated with respect to the base and not be moved towards the door.

Furthermore, the base or rotating part can easily be provided with means to prevent the sliding part to be slidable with respect to the rotating part when the rotating part is in a forward facing position or a rearward facing position of the child seat, even if the second locking means would be unlocked.

In one example, the child seat is pivotable with respect to the rotating part from the forward facing position to the rearward facing position. It is however also possible to be only being pivotable between the forward facing position or the rearward facing position and the side facing position.

In one example, the child seat is pivotable with respect to the rotating part in two different directions to be able to reach a side facing position looking to each of the doors on each sides of the vehicle.

During driving of the vehicle, the sliding direction extends in the driving direction of the vehicle. By means of the second locking means as well as possible other means the sliding part is maintained firmly fixed to the rotating part during such a crash.

An embodiment of the child vehicle seat according to the present disclosure is characterized in that by unlocking the first locking means the rotating part together with the sliding part and child seat are rotatable to the side facing position, whereby near or at the side facing position the second locking means will be automatically unlocked to allow the sliding part together with the child seat to slide in the sliding direction.

By automatically unlocking the second locking means a person operating the child vehicle seat needs only to unlock the first locking means. This simplifies the operation of the child vehicle seat. Furthermore, it blocks the second locking means from being unlocked before the child seat is rotated into the side facing direction.

Another embodiment of the child vehicle seat according to the present disclosure is characterized in that the first locking means comprises a first and second handle located on opposite sides of the child vehicle seat, whereby a locking pin is moved out of a locking hole against spring force by moving the first handle in clockwise direction about the rotation axis or moving the second handle in counter clockwise direction about the rotation axis.

When the child seat is located near one door of the vehicle the shortest way to be rotated to the side facing direction will be clockwise whilst being located to the other door of the vehicle the shortest way to be rotated to the side facing direction facing that door will be counter clockwise. The person operating the child vehicle seat will automatically use the handle being close to the door and automatically move the handle in the correct direction to rotate the child seat towards the door, thereby unlocking the first locking means. The rotation direction of the child seat will hereby depend on whether the child seat starts from the forward facing position or the rearward facing position.

Another embodiment of the child vehicle seat according to the present disclosure is characterized in that the locking pin is movable connected to the rotating part, whilst the locking hole is located in the base.

This has the advantage that the locking pin has a defined position with respect to rotating part, so that independent if the rotating part with the sliding part and the child seat are in a forward facing position or the rearward facing position, the locking pin can always be operated by means of the handles. In this manner the handles are being used to unlock the locking pins as well as to rotate the rotating part after unlocking the first locking means.

Another embodiment of the child vehicle seat according to the present disclosure is characterized in that the first locking means detachably lock the rotating part to the base in the at least forward facing position as well as the rearward facing position.

This has the advantage that with one locking means the rotating part can be locked in both the forward facing position as well as the rearward facing position.

Another embodiment of the child vehicle seat according to the present disclosure is characterized in that the second locking means comprises at least one engagement element movably extending through an opening in the rotating part, which engagement element is movable through the opening from a first position wherein the engagement element is located in an engagement hole of the sliding part and the opening to lock the sliding part with respect to the rotatable part, to a second position wherein the engagement element is located in an engagement hole of the base and the opening to limit rotation of the rotatable part with respect to the base to a predetermined angle.

With the engagement element the rotating part is either locked to the sliding part or to the base. If desired the base can have more than one engagement holes so that the rotating part can be locked with respect to the base in for example both side facing positions. These side facing positions can be predetermined fixed positions in which case the engagement hole of the base part and the opening allow no rotation of the rotatable part with respect to the base if the engagement element is located in the engagement hole of the base part and the opening. However, if desired that at the side facing position the sliding part and the child seat mounted thereon should be allowed to move over a relatively small predetermined angle to compensate for the orientation of the child vehicle seat with respect to the vehicle seat and the door of the vehicle, the engagement hole in the base can be a slot enabling the engagement element to slide in the slot and allowing a limited rotation of the rotatable part with respect to the base.

Another embodiment of the child vehicle seat according to the present disclosure is characterized in that the predetermined angle is in the range from zero degrees to 20 degrees, more preferably 10 degrees.

When being zero degrees the rotatable part is not pivotable with respect to the base. In the range from more than 0 degrees to 20 degrees the rotating part, the sliding part mounted on the rotating part as well as the child seat mounted on the sliding part can slightly rotate with respect to the base so that the child seat can be positioned in a desired side facing position suitable for the vehicle in which the child vehicle seat is mounted.

Another embodiment of the child vehicle seat according to the present disclosure is characterized in that the sliding part is slidable in the sliding direction from a start position via at least one intermediate position to an end position.

At the start position the sliding part is located in the position on the rotating part, wherein the rotating part together with the sliding part can be rotated between the forward facing position, the facing side positions and the rearward facing position. When the rotating part together with the sliding part is in the side facing position, the sliding part is slidable with respect to the rotating part in the sliding direction from the start position via at least one intermediate position to the end position and vice versa.

At the end position the child seat mounted on the sliding part is located near or outside the door of the vehicle. In the at least one intermediate position the child seat mounted on the sliding part is in a position between the start position and the end position. This might be desirable in some situations, for example when the door of the vehicle cannot be completely be opened or if the end position cannot be reached because of specific geometries in the vehicle.

In each position the rotating part remains located above the base.

Another embodiment of the child vehicle seat according to the present disclosure is characterized in that at least at one of the start position, the at least one intermediate position or the end position, the sliding part overcomes a predetermined force before being able to slide from its current position to a next position.

With the need to overcome a predetermined force, the person operating the child vehicle seat will notice when the specific position is being reached. Furthermore, when removing the child seat from or placing the child seat on the sliding part, the siding part will remain its position, unless a force larger that the predetermined force is exerted on the sliding part, making it easier to remove or mount the child seat from or on the sliding part and/or to install the child into the child seat or remove the child from the child seat.

Another embodiment of the child vehicle seat according to the present disclosure is characterized in that the sliding part or the rotating part is provided with a pin being located under the predetermined spring force in a dent located in the other of the sliding part or the rotating part.

With such a pin-dent combination it is relatively simple to define the start position, the intermediate position(s) and/or the end position.

Another embodiment of the child vehicle seat according to the present disclosure is characterized in that the pin has a rounded end being located in a hemisphere shaped dent.

Such a pin-dent combination can easily be made. The force can easily be changed by changing the shape of the dent or the spring force of the spring depending on the desired force to move from one position to the next position.

Another embodiment of the child vehicle seat according to the present disclosure is characterized in that the pin has a frustoconical shaped end being located in a frustoconical shaped dent.

Due to the frustoconical shape the pin and dent can easily be connected and disconnected.

Another embodiment of the child vehicle seat according to the present disclosure is characterized in that the frustoconical shaped dent has inclined walls, having different angles at opposite sides of the dent.

In this manner the force to remove the pin from the dent will be different at the opposite sides. With a large angle it will be easy to move the pin out of the dent whilst with a small angle it will be harder to move the pin out of the dent. In this manner, the dent to define an intermediate position might have different angles so that it is easier to move from the intermediate position to the end position than to the start position, or the other way around, depending on the desired function of the intermediate position.

Another embodiment of the child vehicle seat according to the present disclosure is characterized in that the frustoconical shaped dents have inclined walls, having different angles at the start position, the at least one intermediate position and/or the end position.

Depending on the predetermined angles, it might be easier and requiring less force to move from the intermediate position to the end position or the start position, than from the start position and end position to the intermediate position or the other way around, depending on the desired function of each position.

Another embodiment of the child vehicle seat according to the present disclosure is characterized in that the child seat is detachably connected to the sliding part, whereby the child vehicle seat is provided with unlocking means to unlock the connection between the child seat and the sliding part, which unlocking means are located on a front side as well as on the rear side of the child vehicle seat.

This has the advantage that independent if the child seat is located in a forward facing position or a rearward facing position, a person operating the child vehicle seat can always easily operate either the unlocking means located on the front side or on the rear side of the child vehicle seat.

Another embodiment of the child vehicle seat according to the present disclosure is characterized in that the sliding part is provided with pivotable hooks being connectable to connecting elements of the child seat, whereby the hooks are movable against spring force by means of a movable part to an open position wherein the child seat can be removed from the sliding part, which movable part extends from the front side to the rear side of the child vehicle seat.

The movable part forms the unlocking means.

Another embodiment of the child vehicle seat according to the present disclosure is characterized in that the movable part is provided with an additional movable part being movable in opposite direction as the movable part, whereby a first set of hooks is pivotable by means of the movable part in a first direction, whilst a second set of hooks is pivotable by means of the additional movable part in a second direction being opposite to the first direction.

Preferably by the movable part in one direction will automatically cause the additional movable part to move in opposite direction, so that both sets of hook are being pivoted at the same time to unlock all hooks.

1. A juvenile restraint comprising
a seat base adapted to be mounted to a vehicle seat,
a child vehicle seat adapted to secure a child for transportation in a vehicle, and
a seat-configuration controller configured to change the child vehicle seat between a transportation configuration in which the child faces the front or rear of the vehicle, a lateral-retracted configuration in which the child faces a lateral side of the vehicle, and a lateral-extended configuration in which the child vehicle seat is translated towards a door of the vehicle, the seat-configuration controller including
a seat mount configured to couple with the child vehicle seat for movement therewith,
a seat-pivot unit configured to rotate the child vehicle seat about a center pivot axis between the transportation configuration and the lateral-retracted configuration, and
a seat-slide unit configured to slide the child vehicle seat relative to the seat base between the lateral-retracted configuration and the lateral-extended configuration,
wherein the child vehicle seat, the seat mount, and a first portion of the seat-slide unit extend laterally away from the seat base, the seat-pivot unit, and a second portion of the seat-slide unit when the child vehicle seat is in the lateral-extended configuration so that the seat base, the seat-pivot unit, and the second portion of the seat-slide unit are secure to the vehicle seat while the child is moving into or out of the child vehicle seat or a caregiver is placing or removing the child vehicle seat on or from the seat mount.

2. The juvenile restraint of claim 1, wherein the seat-slide unit includes an arm frame coupled to the seat-pivot unit for movement therewith, a slidable arm movable relative to the arm frame, and a slide controller configured to block movement of the slidable arm relative to the arm frame when the child vehicle seat is in the transportation configuration.

3. The juvenile restraint of claim 2, wherein the slidable arm is movable between a retracted position in which the child vehicle seat is in the lateral-retracted configuration, an extended position in which the child vehicle seat is in the lateral-extended configuration, and one or more intermediate positions between the retracted position and the extended position in which the child vehicle seat is being moved between the lateral-retracted configuration and the lateral-extended configuration.

4. The juvenile restraint of claim 3, wherein the slide controller is further configured to guide movement of the slidable arm between the retracted position, the extended position, and the one or more intermediate positions.

5. The juvenile restraint of claim 4, wherein the slide controller includes a retainer formed in the arm frame at a first end of the arm frame and a soft lock coupled to the slidable arm, the soft lock extending between the slidable arm and the arm frame, the retainer being configured to receive the soft lock when the slidable arm is in the retracted position.

6. The juvenile restraint of claim 2, wherein the arm frame includes a frame plate and at least one bearing coupled to the frame plate, the at least one bearing being configured to engage the slidable arm to encourage movement of the slidable arm relative to the arm frame.

7. The juvenile restraint of claim 2, wherein the slide controller includes a slide lock movable between a slide-locked position in which the slidable arm is blocked from moving relative to the arm frame when the child vehicle seat is in the transportation configuration and a slide-unlocked position in which the slidable arm is allowed to move relative to the arm frame when the child vehicle seat is in one of the lateral-retracted configuration and the lateral-extending configuration, an upper slide-lock receiver formed in the slidable arm, the upper slide-lock receiver being configured to receive the slide lock in the slide-locked position, and a lower slide-lock receiver formed in the seat-pivot unit, the lower slide-lock receiver being configured to receive the slide lock in the slide-unlocked position, and
wherein the lower slide-lock receiver is formed in a hub mount of the seat-pivot unit, the hub mount including an upper surface facing the seat-slide unit to engage the slide lock, push the slide lock upward and into the upper slide-lock receiver when the slide lock is in the slide-locked position.

8. The juvenile restraint of claim 7, wherein the lower slide-lock receiver extends downwardly away from the upper surface to receive the slide lock such that when the slide lock aligns with the lower slide-lock receiver, the slide lock moves the downwardly away from the upper slide-lock receiver and into the lower slide-lock receiver to put the slide lock in the slide-unlocked position.

9. The juvenile restraint of claim 2, wherein the seat mount includes a seat retainer configured to engage the child vehicle seat, a retainer-rotation stop configured to block movement of portions of the seat retainer which engage the child vehicle seat, and a stop release configured to move the retainer-rotation stop away from the seat retainer to allow movement of portions of the seat retainer,
wherein the seat retainer includes one or more rear retainers configured to engage a rear end of the child vehicle seat and one or more front retainers configured to engage a front end of the child vehicle seat, the one or more rear retainers and the one or more front retainers each having a stop-engagement surface configured to engage with the retainer-rotation stop,
wherein the one or more rear retainers are biased to rotate away from the rear end of the child vehicle seat about a rear pivot axis in a first direction and the one or more front retainers are biased to rotate away from the front end of the child vehicle seat about a front pivot axis in a second direction opposite the first direction.

10. The juvenile restraint of claim 1, wherein the seat-pivot unit includes a hub mount coupled to the seat base, a pivot hub coupled to the hub mount, the pivot hub being configured to rotate relative to the hub mount about the center pivot axis, and a pivot controller configured to selectively allow rotation of the pivot hub relative to hub mount to change the child vehicle seat between the transportation configuration and the lateral-retracted configuration.

11. The juvenile restraint of claim 10, wherein the seat-slide unit includes an arm frame coupled to the seat-pivot unit for movement therewith, a slidable arm movable relative to the arm frame, and a slide controller configured to block movement of the slidable arm relative to the arm frame when the child vehicle seat is in the transportation configuration.

12. The juvenile restraint of claim 11, wherein the slidable arm is movable between a retracted position in which the child vehicle seat is in the lateral-retracted configuration, an extended position in which the child vehicle seat is in the lateral-extended configuration, and one or more intermediate positions between the retracted position and the extended position in which the child vehicle seat is being moved between the lateral-retracted configuration and the lateral-extended configuration and, wherein the slide controller is further configured to guide movement of the slidable arm between the retracted position, the extended position, and the one or more intermediate positions.

13. The juvenile restraint of claim 12, wherein the slide controller includes a retainer formed in the arm frame at a first end of the arm frame and a soft lock coupled to the slidable arm, the soft lock extending between the slidable arm and the arm frame, the retainer being configured to receive the soft lock when the slidable arm is in the retracted position.

14. The juvenile restraint of claim 10, wherein the pivot controller includes a pivot lock coupled to the pivot hub, the pivot lock being movable between a pivot-locked position in which the pivot hub is blocked from rotation about the center pivot axis when the child vehicle seat is in the transportation configuration and a pivot-unlocked position in which the pivot hub is allowed to rotate about the center pivot axis to change the child vehicle seat from the transportation configuration to the lateral-retracted configuration, a pivot-lock receiver formed in the hub mount, the pivot-lock receiver being configured to engage the pivot lock in the pivot-locked positon, and a pivot-lock actuator configured to move the pivot lock from the pivot-locked position to the pivot-unlocked position.

15. The juvenile restraint of claim 14, wherein the pivot-lock actuator includes a first pin release coupled to a first lateral side of the pivot hub, a second pin release coupled to a second lateral side of the pivot hub opposite the first lateral side, and a longitudinal rod having a first end coupled to the pivot lock and the first pin release and a second end coupled to the second pin release so that the pivot lock moves from the pivot-locked position to the pivot-unlocked position upon actuation of one of the first pin release and the second pin release.

16. The juvenile restraint of claim 15, wherein the first pin release includes a first handle coupled to the first lateral side of the pivot hub and a first connecting piece coupled to the first handle and the first end of the longitudinal rod so that upon actuation of the first handle about a first handle pivot axis, the first connecting piece moves the longitudinal rod towards the first lateral side of the pivot hub to move the pivot lock from the pivot-locked positon to the pivot-unlocked position, and wherein the second pin release includes a second handle coupled to the second lateral side of the pivot hub, a second connecting piece coupled to the second handle, and a lever coupled to the second connecting piece and the second end of the longitudinal rod so that upon actuation of the second handle about a second handle pivot axis, the second connecting piece rotates the lever about a lever pivot axis and the lever moves the longitudinal rod towards the first lateral side of the pivot hub to move the pivot lock from the pivot-locked positon to the pivot-unlocked position.

17. The juvenile restraint of claim 10, wherein the seat mount includes a seat retainer configured to engage the child vehicle seat, a retainer-rotation stop configured to block movement of portions of the seat retainer which engage the child vehicle seat, and a stop release configured to move the retainer-rotation stop away from the seat retainer to allow movement of portions of the seat retainer,
wherein the seat retainer includes one or more rear retainers configured to engage a rear end of the child vehicle seat and one or more front retainers configured to engage a front end of the child vehicle seat, the one or more rear retainers and the one or more front retainers each having a stop-engagement surface configured to engage with the retainer-rotation stop,
wherein the one or more rear retainers are biased to rotate away from the rear end of the child vehicle seat about a rear pivot axis in a first direction and the one or more front retainers are biased to rotate away from the front end of the child vehicle seat about a front pivot axis in a second direction opposite the first direction.

18. The juvenile restraint of claim 17, wherein the retainer-rotation stop includes a rear retainer-block unit configured to block rotation of the one or more rear retainers in the first direction, a front retainer-block unit configured to block rotation of the one or more front retainers in the second direction, and a bias member configured to urge the rear retainer-block unit and the front retainer-block unit to block rotation of the one or more rear retainers in the first direction and the one or more front retainers in the second direction, and
wherein the stop release includes one or more levers coupled to and interconnecting the sliding arm, the rear retainer-block unit, and the front retainer-block unit, and a release actuator configured to overcome a bias force of the bias member to move the rear retainer-block unit in a forward direction to cause the one or more levers to pull the front retainer-bloc unit in a rearward direction so that the rear-retainer block unit disengages from the one or more rear retainers to allow rotation of the one or more rear retainers in the first direction and the front retainer-block unit disengages from the one or more front retainers to allow rotation of the one or more front retainers in the second direction to release the child vehicle seat from the seat mount.

19. A juvenile restraint comprising
a seat base adapted to be mounted to a vehicle seat,
a child vehicle seat adapted to secure a child for transportation in a vehicle, and
a seat-configuration controller configured to allow the child vehicle seat to rotate about a center pivot axis between a transportation configuration in which the child faces the front or the rear of the vehicle and a lateral-retracted configuration in which the child faces a lateral side of the vehicle,
wherein the seat-configuration controller further allows the child vehicle seat to slide relative to the seat base between the lateral-retracted configuration and a lateral-extended configuration in which the child vehicle seat and a first portion of the seat-configuration controller is translated towards a door of the vehicle so that the seat base and a second portion of the seat-configuration controller are secure to the vehicle seat while a child moves in and out of the child vehicle seat or a caregiver is placing or removing the child vehicle seat on or from the seat-configuration controller.

20. The juvenile restraint of claim 19, wherein the seat-configuration controller includes a seat mount configured to couple with the child vehicle seat for movement therewith, a seat-pivot unit configured to position the child vehicle seat in one of the transportation configuration and the lateral-retracted configuration, and a seat-slide unit configured to position the child vehicle seat in one of the lateral-retracted configuration and the lateral-extended configuration.

21. The juvenile restraint of claim 20, wherein the seat-slide unit includes including an arm frame coupled to the seat-pivot unit and a slidable arm movable relative to the arm frame.

22. The juvenile restraint of claim 21, wherein the child vehicle seat, the seat mount, and the slidable arm are at least partially translated towards the door of the vehicle when the child vehicle seat is in the lateral-extended configuration and the seat base, the seat-pivot unit, and the arm frame are secure to the vehicle seat when the child vehicle seat is in the lateral-extended configuration.

23. The juvenile restraint of claim 21, wherein the seat-slide unit further includes a slide controller configured to block movement of the slidable arm relative to the arm frame when the child vehicle seat is in the transportation configuration.

24. The juvenile restraint of claim 21, wherein the seat-slide unit further includes a slide controller configured to selectively guide movement of the slidable arm relative to the arm frame when the child vehicle seat is moved between the lateral-retracted configuration and the lateral-extended configuration.

25. The juvenile restraint of claim 24, wherein the slidable arm is movable between a retracted position in which the child vehicle seat is in the lateral-retracted configuration and an extended position in which the child vehicle seat is in the lateral-extended configuration.

26. The juvenile restraint of claim 25, wherein the slide controller includes an end retainer formed at a first end of the arm frame and the slidable arm includes a soft lock extending between the slidable arm and the arm frame and having a bias force, the end retainer being configured to receive the soft lock when the slidable arm is in the retracted positon, and wherein the slidable arm is movable from the retracted position when a predetermined force that overcomes the bias force is applied to the soft lock.

27. The juvenile restraint of claim 21, wherein the arm frame includes a frame plate and at least one bearing coupled to the frame plate and being configured to engage the slidable arm to encourage movement of the slidable arm between the retracted position and the extended position.

28. A juvenile restraint comprising
a seat base detachably connectable to a vehicle seat,
a rotating part being rotatable with respect to the seat base about a rotation axis from at least a forward facing position or a rearward facing position seen in a driving direction of the vehicle in use to a side facing position directed to a door of the vehicle and vice versa,
a sliding part being slidable with respect to the seat base in a sliding direction substantially perpendicular to the driving direction of the vehicle,
a child vehicle seat connected to the seat base via the sliding part and the rotating part,
wherein the child vehicle seat and the sliding part are slidable together with respect to the rotating part,
wherein the juvenile restraint further comprises first locking means to detachably lock the rotating part to the seat base in the at least forward facing position or rearward facing position, as well as second locking means to detachably lock sliding of the sliding part with respect to the rotating part.

29. The juvenile restraint of claim 28, wherein by unlocking the first locking means the rotating part together with the sliding part and child vehicle seat are rotatable to the side facing position, whereby near or at the side facing position the second locking means will be automatically unlocked to allow the sliding part together with the child vehicle seat to slide in the sliding direction.

30. The juvenile restraint of claim 28, wherein the first locking means comprises a first and second handle located on opposite sides of the child vehicle seat, whereby a locking pin is moved out of a locking hole by moving the first handle in clockwise direction about the rotation axis or moving the second handle in counter clockwise direction about the rotation axis.

31. The juvenile restraint of claim 30, wherein the locking pin is movably connected to the rotating part, whilst the locking hole is located in the seat base.

32. The juvenile restraint of claim 28, wherein the first locking means detachably lock the rotating part to the seat base in the at least forward facing position as well as the rearward facing position.

33. The juvenile restraint of claim 28, wherein the second locking means comprises at least one engagement element movably extending through an opening in the rotating part, which engagement element is movable through the opening from a first position wherein the engagement element is located in an engagement hole of the sliding part and the opening to lock the sliding part with respect to the rotatable part, to a second position wherein the engagement element is located in an engagement hole of the seat base and the opening to limit rotation of the rotatable part with respect to the seat base to a predetermined angle.

34. The juvenile restraint of claim 33, wherein the predetermined angle is in the range from zero degrees to 20 degrees.

35. The juvenile restraint of claim 34, wherein the predetermined angle is in a range from 5 degrees to 15 degrees.

36. The juvenile restraint of claim 35, wherein the predetermined angle is 10 degrees.

37. The juvenile restraint of claim 28, wherein the sliding part is slidable in the sliding direction from a start position via at least one intermediate position to an end position.

38. The juvenile restraint of claim 37, wherein the at least at one of the start position, the at least one intermediate position or the end position, the sliding part overcomes a predetermined force before being able to slide from its current position to a next position.

39. The juvenile restraint of claim 38, wherein the sliding part or the rotating part is provided with a pin being located under the predetermined force in a dent located in the other of the sliding part or the rotating part.

40. The juvenile restraint of claim 39, wherein the dents have inclined walls, having different angles at the start position, the at least one intermediate position and/or the end position.
